(19) United States
(12) Patent Application Publication
(10) Pub. No.: US 2021/0245291 A1
(43) Pub. Date: Aug. 12, 2021

(54) METHOD FOR ASSEMBLING A FIRST PART AND A SECOND PART VIA AN INSERT

(71) Applicant: Maxime GROJEAN, Commercy (FR)

(72) Inventor: Maxime GROJEAN, Commercy (FR)

(21) Appl. No.: 16/973,274

(22) PCT Filed: Jun. 7, 2019
(86) PCT No.: PCT/FR2019/051373

§ 371 Date: Dec. 8, 2020

(30) Foreign Application Priority Data
Jun. 8, 2018 (FR) 18/54992

(51) Int. Cl. B23K 11/00

(52) U.S. Cl. CPC B23K 11/0066; B23K 2103/04

(57) ABSTRACT

A method enables the assembly of a first part and of a second part via an insert including a head intended to bear on the first part and a body including an end portion intended to be welded to the second part. The method includes, before fastening of the end portion of the body of the insert on the second part, a step of conforming the first or the second part so as to form a decoupling area around this end portion.

The present invention concerns a method for assembling a first part and a second part via an insert.

It is known, in particular in the land or air transportation field, to make multi-material assemblies integrating, at the same time, components such as steel, aluminum, magnesium, a thermosetting or thermoplastic plastic, a composite reinforced with glass or carbon fibers, whether woven or not. These multi-material assemblies address problems related to vehicles weight reduction in order to reduce energy consumption or improve the dynamic behavior of the vehicle, structural reinforcement in order to meet safety-related requirements, or else reduction of the number of components in vehicles.

However, multi-material assemblies are relatively difficult to implement given the very nature of these assemblies, requiring fastening parts made of materials with different properties in an easy, economical, durable and robust way.

It is known to make multi-material assemblies for example by gluing. However, this solution generally involves a relatively long cross-linking or setting time and may also have the drawback of an alteration of the performances of the assembly by the ageing effect, such that its application remains restricted to well-defined cases.

It is also known to make multi-material assemblies by means of flowhole-forming screws, rivets, or else nails. However, these solutions do not enable making of assemblies including in particular high-performance steel sheet metals. Another drawback relates to the existence of a residual projecting protrusion after assembly.

Finally, it is known to make assemblies by a spot welding technique, in particular during a body-in-white construction operation. Spot welding or electric resistance welding is an assembly solution that has the advantage of being both economical and effective from a mechanical perspective. Nonetheless, this technique is restricted to the assembly of two elements made of a material of the same kind, typically like two steel sheet metals. This technique turns out to be complex to implement when the assembly to be made comprises elements with materials of different kinds, such as for example an aluminum-steel, steel-composite, aluminum-plastic assembly, etc. To solve this, it is known to use inserts, also called welding patches, which are positioned in one of the elements to be assembled and on which the welding electrode is applied to achieve the assembly. Hence, these welding patches allow making multi-material assemblies.

However, welding patches have several drawbacks. The dimensions, in particular the diameter, of welding patches are generally large. Indeed, this allows ensuring docking of the electrodes of a welding clamp on the patches rather than the part in which the patch is inserted, without the addition of a vision positioning system for this purpose on welding robotic arms. In addition, this allows dissipating the heat generated during welding before this heat reaching and melting or altering the material of the part into which the welding patch is inserted. This relatively large sizing involves a high material cost, as well as an increased mass, in opposition with the current issue of vehicles weight reduction. Henceforth, the integration of welding patches into the part to be assembled requires the arrangement of holes with a diameter adapted to these welding patches, and therefore, in turn, with a relatively large diameter, which tends to weaken the part receiving the welding patches. Besides, it is still complex to effectively integrate welding patches into parts made for example of a plastic or composite material.

Also, the invention aims at overcoming all or part of these drawbacks by providing a method for assembling a first part and a second part in a robust, quick and economical way.

To this end, an object of the invention is a method for assembling a first part and a second part via an insert comprising a head intended to bear on the first part and a body comprising an end portion intended to be welded to the second part, characterized in that the method comprises, before fastening of the end portion of the body of the insert on the second part, a step of conforming the first or the second part so as to form a decoupling area around this end portion.

Thus, the method according to the invention allows achieving a multi-material assembly by electric resistance welding, this assembly being robust, with limited material costs, adapted to be carried out with existing resistance welding equipment, which also allows reducing costs.

Indeed, the thermal decoupling area around the end portion, that is to say around the melt spot, allows limiting a heat transmission to the first part. This limits the risk of altering, by the effect of the temperature rise, a material of the first part, which is particularly advantageous when the first part comprises a plastic material, which may for example consist of the matrix of a composite.

According to one embodiment, the decoupling area is an air cavity.

According to one embodiment, the decoupling area extends in an annular manner around the body.

According to one embodiment, the method comprises a step of integrating the insert into the first part.

According to one embodiment, the step of integrating the insert into the first part and the step of conforming the first part in order to form the decoupling area are concomitant.

According to one embodiment, the step of integrating the insert into the first part is prior to the step of conforming the first or the second part in order to form the decoupling area.

According to one embodiment, the step of integrating the insert into the first part is subsequent to the step of conforming the first or the second part in order to form the decoupling area.

According to one embodiment, the integration step comprises a step of cutting, through the first part, a hole intended for the passage of the body of the insert.

For example, the cutting step is carried out upon closure of a mold or of a stamping press.

According to one embodiment, the decoupling area is formed by leaving room for a free space intended to receive the body of the insert.

According to one embodiment, the decoupling area is formed by deformation of the first or of the second part.

According to one embodiment, the end portion of the body of the insert is fastened to the second part by electric resistance welding.

According to one embodiment, the first part is made by injection molding.

Other features and advantages of the present invention will appear clearly from the detailed description hereinafter of one embodiment provided as a non-limiting example, with reference to the appended drawings in which:

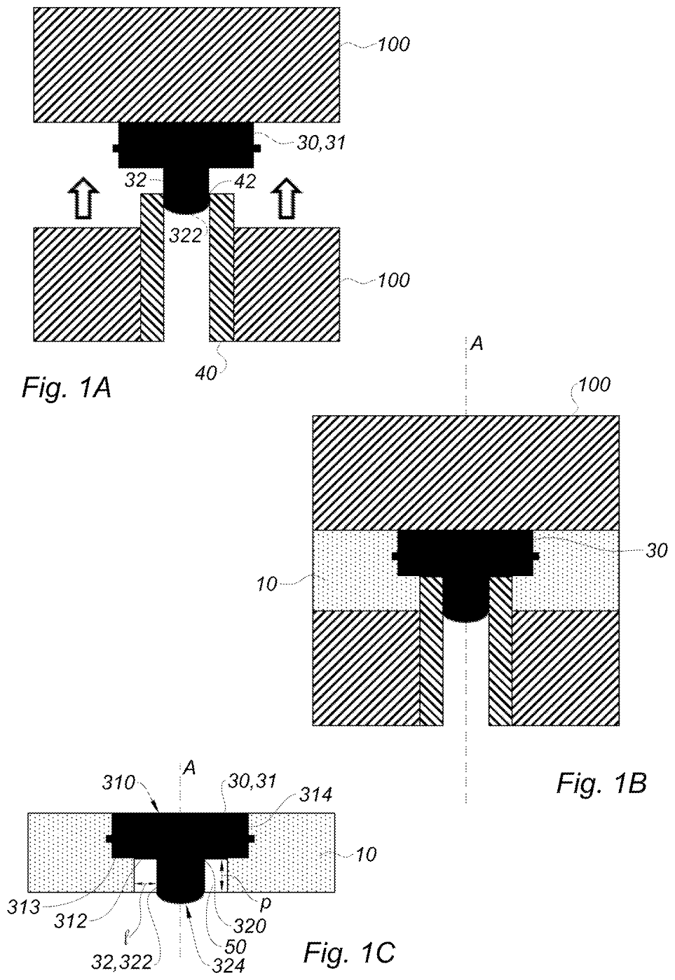

FIGS. 1A, 1B and 1C are schematic views illustrating steps of a method according to an embodiment of the invention,

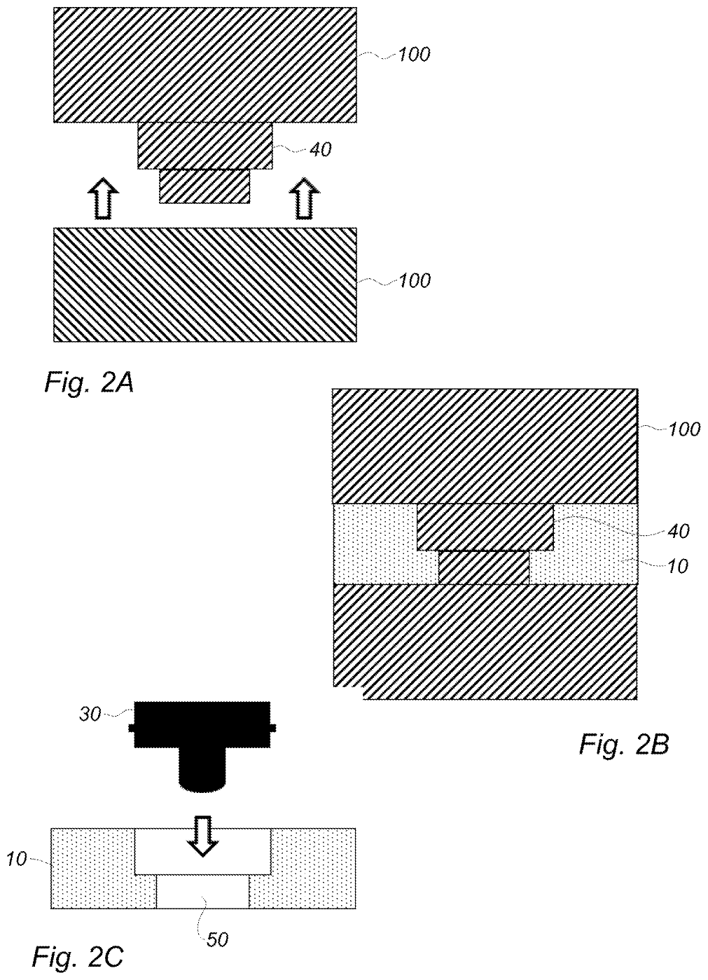

FIGS. 2A, 2B and 2C are schematic views illustrating steps of a method according to an embodiment of the invention,

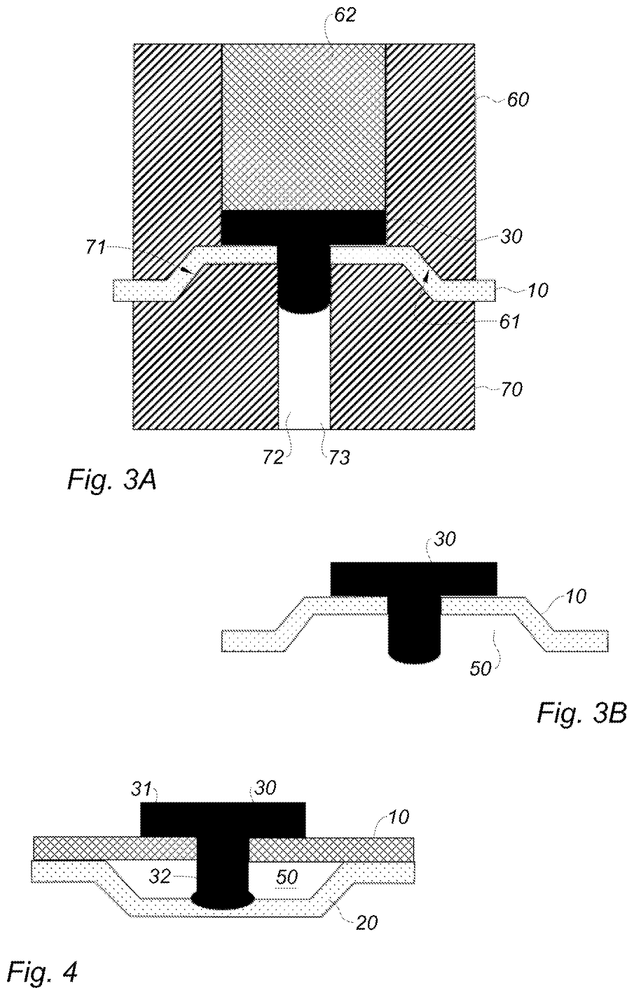

FIGS. 3A and 3B are schematic views illustrating steps of a method according to an embodiment of the invention,

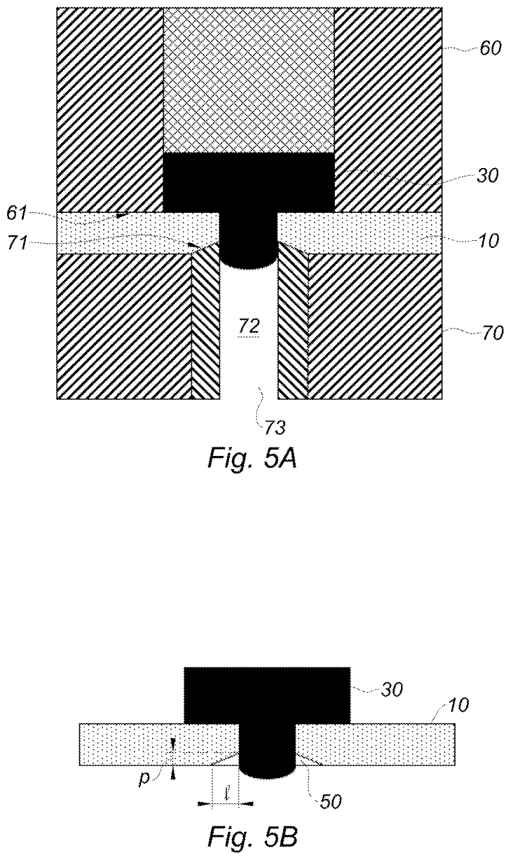

FIG. 4 is a schematic view of a step of a method according to an embodiment of the invention,

FIGS. 5A and 5B are schematic views illustrating steps of a method according to an embodiment of the invention.

FIGS. 1 a to 1C show steps of a method according to an embodiment of the invention. The method is intended for the assembly of a first part 10 and of a second part 20, which may consist of a first sheet metal and a second sheet metal, by means of an insert 30.

The first part 10 and the second part 20 may comprise different materials. As example, the first part 10 may be made of a plastic or composite material, for example with a thermoplastic or thermosetting matrix and short or long fibers type reinforcements, whereas the second part 20 may be made of a metal, for example steel. When the first part 10 is made of an electrically-conductive material, for example metallic, the insert 30 may be partially or completely covered with an electrically-insulating coating to avoid a short-circuit.

The insert 30 comprises a head 31 and a body 32 which extends from the head 31, longitudinally, according to an axis A orthogonal to the head 31. The head 31 may have a disk-like shape, or any other shape, for example square or a shape having a polygonal- or hexalobular-type external footprint. The body 32 may have a cylindrical shape, or possibly any other shape, for example a prism-like shape, with a polygonal section. The head 31 and the body 32 may be integrally made in one-piece, or else be fastened to one another so as to form the insert 30. Advantageously, the head 31 has a cross-section, that is to say orthogonal to the axis A, that is larger than that of the body 32. Preferably, the body 32 extends centrally from the head 31 so that the electric current lines flowing through the insert 30 during the electric resistance welding operation concentrate at the center of the insert 30. In this instance, the insert, as such, is devoid of any decoupling means.

Advantageously, the head 31 comprises a proximal face 310, which is intended to receive a welding electrode (not represented), and an opposite distal face 312, from which extends the body 32 in this instance. Advantageously, the distal face 312 delimits a bearing surface 313 intended to bear against the first part 10 in order to hold the assembly of the first and second parts 10, 20. The head 31 has a lateral face 314 which may be provided with means for holding the head 31 in the first part 10, such as for example lugs 316. The lateral face 314 links the proximal and distal faces 310, 312.

Although this is not represented, the proximal face 310 may feature one or several vent channel(s), for example intended for the circulation of a cooling fluid. The vent channels may have a radial opening leading sideways and enabling the discharge of the cooling fluid. The head 31, in particular the proximal face 310, may further comprise an engagement surface, for example orthoradial or with an orthoradial component, configured to receive a tool, for example a screwdriver or a key, in order o apply a force, in particular a torque, onto the head 31 intended to break up fastening of the insert 30 on the second part 20. This engagement surface may correspond to a lateral wall of the vent channel(s) or to a portion of the lateral face 314.

The body 32 of the insert 30 has a proximal portion 320, which may be secured to the head 31, in particular to its distal face 312, as well as a distal end portion 322, opposite to the proximal portion 320, intended to be fastened to the second part 20, by electric resistance welding or by friction. The end portion 322 has a welding surface 324, which is intended for the welding of the body 32 of the insert 30 on the second part 20. Advantageously, the welding surface 324 delimits a decreasing cross-section; it may for example be spherical, conical or frustoconical. Thus, the body 32 may have a section difference in a distal direction, in order to concentrate, in a very localized manner, the heat after welding has been initiated. The welding surface 324 may terminate in a primer (not represented).

Advantageously, the insert 30 is intended to enable an electric resistance welding, also called electric spot welding. Thus, the insert 30 is adapted to be crossed by an electric current in order to enable a welding of the insert 30 and of the second part 20, the first part 10 being held assembled to the second part 20 by the insert 30. Thus, the head 31 and the body 32 are configured to enable the flow of an electric current from the proximal face 310 up to the welding surface 324.

In particular, the head 31 and the body 32 of the insert 30 comprise an electrically-conductive material, for example metallic. The insert 30, and in particular the head 2 and/or the body 4, may thus comprise steel, aluminum, titanium or copper.

According to one possibility, the head 31 may comprise a first material and the body 32 may comprise a second material distinct from the first material, in particular with an electric resistivity that is higher than that of the first material, so as to create an electric resistivity difference between the head 31 and the body 32, in order to localize the electric power, and therefore the generated heat, at the center of the insert 30. For example, the head 31 comprises aluminum, the body 32 comprising steel.

Advantageously, the body 32 may comprise several materials having different electric resistivities: for example, the distal end portion 322 may comprise a material with an electric resistivity that is higher than the rest of the body 32.

The assembly method according to the invention comprises a step of integrating the insert 30 into the first part 10, a step of conforming the first or second part 10, 20 so as to create a decoupling area 50 at least around the end portion 322 of the body 32 of the insert 30, and a step of fastening the insert 30, more specifically of the end portion 322 thereof, to the second part 20 in order to complete the assembly of the first and second parts 10, 20.

The step of integrating the insert 30 to the first part 10 may be carried out before, after or simultaneously with the step of conforming the decoupling area 50.

The step of integrating the insert 30 may be performed as a rework, in particular by deformation of a portion of the insert 30 or of the first part 10, for example by crimping or riveting. The insert 30 may also be screwed or pivotally inserted into the first part 10, in particular if the insert 30 is provided with projections such as lugs or notches intended to be engaged with the first part 10. The integration step may be carried out during a body-in-white construction operation.

Moreover, the integration step may comprise a cutting of the first part 10 to materialize a housing which will enable the set-up of the insert 1, in particular in the case of a first part 100 made of composites, carried out on the base of a structure or of a reinforcement based on long fibers, whether structured or not. The cutting step may be performed upon closure of a mold or of a tooling, that is to say upon formation of the first part 10, for example by means of a hollow tube intended to cut a material piece or ribbon in the first part 10. A discharge of this material piece or ribbon may be performed before opening of the mold or of the tooling, through the inside of the tube having generated the cutout. The discharge may be carried out by means of the insert 30 which, during the insertion thereof inside the hole generated by the cutout, is brought the push the piece or ribbon into the tube. Cutting of a material piece or ribbon may also concern a first metallic part 10 (FIGS. 3A to 5B), made for example of aluminum, which is carried out by cutting-stamping, in particular in transfer press type tooling.

The step of conforming the decoupling area 50 may be carried out by leaving room for a free space, for example by means of a core, intended to receive the body 32 of the insert 30, in particular at the time of formation of the first part 10, or, where appropriate, of the second part 20. Thus, this step may be concomitant with the formation of the first part 10 or of the second part 20.

Alternatively, the step of conforming the decoupling area 50 may be carried out by plastic deformation of the first part 10 or of the second part 20. Thus, this step may be subsequent to the formation of the first part 10 or of the second part 20.

According to the example of FIGS. 1A to 1C, the method comprises an injection step to form the first part 10. The integration of the insert 30 into the first step 10 is herein concomitant with the formation of the first part 10, that is to say with the injection step.

As illustrated in FIG. 1A, the insert 30 is placed within a mold 100 intended for the injection of the first part 10. The method comprises a step of positioning the insert 30 within the mold 100 before injection of the material intended to form the first part 10. This positioning step comprises the insertion of the body 32 into a core 40 equipping the mold 100 and intended to leave room for a decoupling area around the body 32 during the formation of the first part 10, that is to say during the injection, by preventing the injected material from coming into contact with the body 32, and in particular with the end portion 322, as illustrated in FIG. 1B. The core 40, herein shaped like a hollow tube, preferably cylindrical, has an opening 42 enabling at least one portion or the entirety of the body 32 of the insert 30 to be inserted inside the core 40 upon closure of the mold 100. Preferably, the inside of the core 40 and the body 32 of the insert 30 have a complementary shape. Advantageously, the core 40 may abut against the head 2, and more specifically against the distal face 312, once the mold 100 is closed. Hence, the insert 30 may be overmolded and thus be linked to the first part 10. This overmolding may be accompanied by a deformation of the insert 30 to reinforce the mechanical interaction between the insert 30 and the first part 10.

After injection, the first part 10, equipped with the insert 30, has a decoupling area 50 around the body 32 of the insert 30. In a subsequent step, the end portion 322 is fastened to the second part 20, for example by electric resistance welding, in order to assemble the first and second parts 10, 20.

According to the example of FIGS. 2A to 2C, the method comprises an injection step to form the first part 10. The integration of the insert 30 into the first part 10 is herein subsequent to the formation of the first part 10, that is to say at the injection step.

The mold 100 is provided with a core 40 configured to leave room for a decoupling area 50, during the formation of the first part 10, that is to say during the injection, as illustrated in FIG. 2B. The core 40 may also be configured so as to leave room for the insertion of the insert 30 into the first part 10. Thus, the core 40 may have a shape similar to that of the insert 30, except the portion corresponding to the body 32, which shall be larger than the body 32 in order to conform the decoupling area 50 around the body 32. After injection, as shown in FIG. 2C, the first part 10 comprises the decoupling area 50, and may advantageously comprise a housing 12 intended to receive the insert 30, in particular the head 31. Afterwards, the method comprises the reintegration of the insert 30 illustrated in FIG. 2C. This integration step comprises the positioning of the body 32 in the decoupling area 50 formed by the first part 10. Afterwards, the method comprises the step of fastening the end portion 322 to the second part 20, for example by electric resistance welding.

According to the example of FIGS. 3A, 3B, 4 and 5A, 5B, the step of conforming the decoupling area 50 is carried out by deformation of the first part 10 (FIGS. 3A, 3B, 5A, 5B) and/or of the second part 20 (FIG. 4). For example, this deformation may be obtained by stamping (FIGS. 3A, 3B, 4) or by compression (FIGS. 5A, 5B) of the first or second part 10, 20. The step of integrating the insert 30 into the first part 10 may take place before the step of conforming the decoupling area 50 (FIGS. 3A, 3B, 5A), for example when it is the first part 10 which is actually conformed to form the decoupling area 50, or after (FIG. 4), for example when it is the second part 20 which is conformed so as to form the decoupling area 50. The step of conforming the decoupling area 50 may be carried out by means of a tooling comprising a first portion 60 and a second portion 70 intended to be pressed against one another so as to conform the decoupling area 50. The first portion 60 comprises a conformation face 61 which may be planar (FIG. 5A) or which may be concave (FIG. 3A) to form a cavity. The second portion 70 comprises a conformation face 71 which forms an excrescence intended to deform the first or second part 10, 20 when this first or second part 10, 20 is positioned between the conformation faces 61, 71 and the first and second portions 60, 70 of the tooling are pressed against one another. The first portion 60 may have a housing 62, for example a conduit which may in particular open on either side of the first portion 60, intended to house the insert 30, in particular its head 31. The second portion 70 may have a conduit 72 intended to receive the body 32 of the insert 30. This conduit 72 may allow receiving cutouts formed through the first part 10. Advantageously, the conduit 72 has a discharge opening 73 to evacuate these cutouts.

The decoupling area 50 is intended to be interposed between the end portion 322 and the first part 100. Advantageously, the decoupling area 50 consists of a cavity. This cavity comprises a heat-insulating material, in particular air. The decoupling area 50 extends all around the body 32, and in particular at least all around the end portion 322. The decoupling area 50 forms a decoupling ring extending 360° around the body 32. The decoupling area 50 may comprise a part, possibly attached, or a coating, made of a heat-insulating material, for example ceramic, that could, where appropriate, be positioned partially or totally inside the cavity formed in the first part 10 or the second part 20.

It should be highlighted that the body 32 may be configured so as to surpass with respect to a face of the first part 10, as illustrated for example in FIG. 1C, after integration of the insert 30 into this first part 10. The excess material of the body 32, surpassing from the lower face of the first part 10, is distributed radially in the decoupling area 50 during the operation of welding on the second part 20. Hence, the cavity forming the decoupling area 50 increases the range of thickness compatibility of the insert 30 with the first part 10. In addition, this exceedance of the body 32 with respect to the first part 10 enables feeding of the melt formed between the end portion 322 and the second part 20 during the welding operation, that is to say the melt is fed with the material of the body 32. This allows obtaining a better weld quality and avoids a so-called «sticking» phenomenon likely to make the link fragile and less robust.

Referring to FIG. 1C, the decoupling area 50 may have in particular a depth p equal to or larger than 0.06 times the diameter or the width of the body 32 of the insert 30. Moreover, the decoupling area 50 may have a radial width I, that is to say a distance separating the body 32 from the first part 10 in a plane orthogonal to the axis A, equal to or larger than 0.2 times the diameter or the width of the body 32 of the insert 30.

Advantageously, the step of fastening the insert 30 to the second part 20 is carried out by electric resistance welding. A welding electrode (not represented) is applied on the insert 30 or its head 31, more specifically on the proximal face 310. Advantageously, this welding electrode may have a section that is larger than or equal to the section of the head 31.

The fastening step may comprise the application of a second welding electrode (not represented), on the second part 20, more particularly opposite the insert 30. The section or the dimensions, in particular the diameter, of this second electrode may be smaller than the section or the dimensions, in particular the diameter, of the electrode applied on the insert 30, for example similar to the section or the dimensions, such as the diameter, of the body 32 of the insert 30.

It should be noted that the fastening step may, however, comprise the use of one single welding electrode corresponding to the welding electrode applied on the head 31 of the insert 30, in order to achieve a single-access welding. In the case where one single electrode is used, the second part 20, or, where appropriate, a part directly or indirectly bearing against the second part 20 such as a third sheet metal or fourth sheet metal, is, for example, connected to the ground or to an opposite polarity.

The cavity formed by the decoupling area 50 enables, during the fastening step, a buckling of the second part 20. The portion of this second part 20 that faces the insert 30 is deformed by cambering inwards of the decoupling area 50 as welding progresses. This deformation results from the consumption of the material of the body 32 and from the pinch effect exerted by the electrodes, compensating for the reduction of the length of the body 32. Thus, a tension tending to press the first part 10 and the second part 20 is stored during the fastening step.

The method may comprise a step of cooling the insert 30, comprising in particular the circulation of a cooling fluid, such as air, and more specifically compressed air, through a conduit of the welding electrode, and its projection in the direction of the insert 30, in particular of the head 31. Afterwards, the cooling fluid may flow through vent channels, formed on the head 31, more specifically on the proximal face 310, or on the welding electrode. Cooling may be performed by cooling fluid supply, in particular in a central manner, from inside the welding electrode, from outside the welding electrode, in a peripheral manner, for example by means of nozzles arranged around the welding electrode. Preferably, the cooling step takes place during, and/or after, the fastening step, that is to say during and/or after the circulation of an electric current through the insert 30.

The method may comprise a step of gluing the first part 10 and the second part 20. This gluing step may take place before the step of fastening the insert 30 on the second part 20. This welding fastening step may occur before drying and/or cross-linking of the glue. More particularly, the gluing step may comprise: a deposition of glue over the first and/or the second part 10, 20, then, where appropriate, a localization of the first and second parts 10, 20 relative to one another, and a step consisting in exerting a pressure on the insert 30 in order to achieve docking, that is to say contact, between the first and second parts 10 and 20, this pressing step preferably occurring at the time of fastening the insert 30 on the second part 20. The glue may cure or cross-link during this fastening step or during subsequent steps, such as for example an electrophoretic deposition type processing step.

Of course, the invention is not limited to the above-described embodiment, this embodiment having been provided only as example. Modifications are still possible, in particular with regards to the constitution of the various elements or by substitution with technical equivalents, yet without departing from the scope of the invention.

Thus, the method could enable the assembly of more than two parts 10, 20. Where appropriate, these parts, or sheet metals, are stacked, the head of the insert may be fastened to one of the two end sheet metals whereas the end portion of the body of the insert is fastened to the other one of the two end sheet metals.

1. A method for assembling a first part and a second part via an insert comprising a head intended to bear on the first part and a body comprising an end portion intended to be welded to the second part, characterized in that the method comprises, before fastening of the end portion of the body of the insert on the second part, a step of conforming the first or the second part so as to form a decoupling area around this end portion.

2. The assembly method according to claim 1, wherein the decoupling area is an air cavity.

3. The assembly method according to claim 1, wherein the decoupling area extends in an annular manner around the body.

4. The assembly method according to claim 1, wherein the method comprises a step of integrating the insert into the first part.

5. The assembly method according to claim 4, wherein the step of integrating the insert into the first part and the step of conforming the first part in order to form the decoupling area are concomitant.

6. The assembly method according to claim 4, wherein the step of integrating the insert into the first part is prior to the step of conforming the first or the second part in order to form the decoupling area.

7. The assembly method according to claim 4, wherein the step of integrating the insert into the first part is subsequent to the step of conforming the first or the second part in order to form the decoupling area.

8. The assembly method according to claim 4, wherein the integration step comprises a step of cutting, through the first part, a hole intended for the passage of the body of the insert.

9. The assembly method according to claim 1, wherein the decoupling area is formed by leaving room for a free space intended to receive the body of the insert.

10. The assembly method according to claim 1, wherein the decoupling area is formed by deformation of the first or of the second part.

11. The assembly method according to claim 1, wherein the end portion of the body of the insert is fastened to the second part by electric resistance welding.

12. The assembly method according to claim 1, wherein the first part is made by injection molding.
